(19) United States
(12) Patent Application Publication
(10) Pub. No.: US 2025/0234849 A1
(43) Pub. Date: Jul. 24, 2025

(54) Helical Line Lock with Flexible Retainer and Method of Use

(71) Applicant: Australian Business Projects PTY LTD, Logan Central, Queensland (AU)

(72) Inventor: Jason McMillan, Logan Central, Queensland (AU)

(21) Appl. No.: 18/419,272

(22) Filed: Jan. 22, 2024

(51) Int. Cl. A01K 91/04; A01K 83/00

(52) U.S. Cl. CPC A01K 91/04; A01K 83/00

(57) ABSTRACT

A helical line lock for securing a flexible line thereto, the helical line lock including a shank having a first end and an opposing second end and a first helical coil extending from the first end of the shank, the first helical coil comprising a plurality of helical loops disposed in consecutive order. The plurality of helical loops include a plurality mounting loops extending in consecutive order from the first end of the shank and a pair of fixing loops extending in consecutive order following the plurality of mounting loops. A retainer is disposed over at least a portion of one of the pair of fixing loops, the retainer being made of a resiliently flexible material that is more flexible than the first helical coil.

### CROSS-REFERENCE TO RELATED APPLICATIONS

Not applicable.

### BACKGROUND OF THE INVENTION

### 1. The Field of the Invention

The present invention relates to line locks for securing a flexible line and, more particularly, to fishhooks having a line lock with flexible retainer for releasable securing a fishing line thereto.

### 2. The Relevant Technology

Although there are numerous different ways of tying a fishing line onto a fishhook, the process can be daunting to many as it generally requires both good dexterity and vision. For example, the process generally requires feeding the end of the fishing line through a minute eye on a fishhook, wrapping the free end of the line around the main line body, feeding the free end of the line through a loop formed by the wrapping process, and then pulling the line taught. The process can be challenging to the elderly who may lack the needed dexterity and visually acuity. Furthermore, the process can be frustrating and time consuming for both the novice and the impatient. The difficulty of the process is further compounded by the small diameter of the fishing line and the fact that the fishing line is frequently translucent.

In one attempt to overcome the drawbacks associated with conventional fishhook tying techniques, U.S. Pat. No. 7,836,629 discloses forming a helical coil on the fishhook. The fishing line is secured to the coil by wrapping the line around helical coil in different directions and finally pulling the line between two directly adjacent volutes of the helical coil to secure the line to the fishhook. Although the helical coil addresses some shortcomings of conventional tying techniques, other shortcomings are presented. Namely, pulling the line between the two directly adjacent volutes frequently causes the fishing line to either break during the tying process or to be damaged which can lead to failure of the fishing line at a later time.

Accordingly, what is needed in the art are techniques for tying fishing line to fishhooks that address the shortcoming associated with both conventional tying techniques and the shortcoming associated with using the coil in the '629 patent. In addition, what is needed in the art are tying apparatus that provide a simply, quick, and efficient way to secure a flexible line, independent of the diameter size, that do not require exceptional dexterity or visual acuity and do not require the knowledge or use of complex knot tying techniques.

### BRIEF DESCRIPTION OF THE DRAWINGS

Various embodiments of the present invention will now be discussed with reference to the appended drawings. It is appreciated that these drawings depict only typical embodiments of the invention and are therefore not to be considered limiting of its scope.

FIG. 1 is an elevated side view of a fishhook incorporating a helical line lock;

FIG. 2 is an enlarged elevated side view of the helical line lock shown in FIG. 1;

FIG. 3 is a perspective view of a tubular embodiment of a retainer of the helical line lock shown in FIG. 2;

FIGS. 4A-4C are cross sectional views of the line lock shown in FIG. 2 showing steps for securing a flexible line thereto;

FIG. 5 is an elevated side view of an alternative embodiment of the line lock shown in FIG. 2 wherein portions of the retainer overlying the first and second fixing loops are spaced apart;

FIG. 6 is an elevated cross sectional side view of an alternative embodiment of the line lock shown in FIG. 2 wherein one of the pair of fixing loops is disposed at an angle different from the other fixing loop;

FIG. 7 is an elevated side view of an alternative embodiment of the line lock shown in FIG. 2 wherein the retainer only extends over one of the pair of fixing loops;

FIG. 8 is an elevated side view of an alternative embodiment of the line lock shown in FIG. 2 wherein the helical coil is shown having four mounting loops;

FIG. 9 is an elevated side view of an alternative embodiment of the line lock shown in FIG. 2 wherein the mounting loops are separated from the fixing loops by a spacer shaft;

FIG. 10 is an elevated side view of an alternative embodiment of the line lock shown in FIG. 2 wherein the mounting loops are spaced apart farther than the fixing loops;

FIG. 11 is an elevated side view of an alternative embodiment of the line lock shown in FIG. 10 wherein the retainer extends over both the fixing loops and the mounting loops;

FIG. 12 is an elevated side view of a first embodiment of a flexible line coupler including first and second helical line locks;

FIG. 13 is an elevated side view of a second embodiment of a flexible line coupler including a first helical line lock and a clip; and

FIG. 14 is an elevated side view of one embodiment of a swivel including first and second helical line locks.

### DETAILED DESCRIPTION OF THE PREFERRED EMBODIMENTS

Before describing the present disclosure in detail, it is to be understood that this disclosure is not limited to particularly exemplified apparatus, systems, assemblies, methods, or process parameters that may, of course, vary. It is also to be understood that the terminology used herein is only for the purpose of describing particular exemplary embodiments of the present disclosure and is not intended to limit the scope of the disclosure in any manner.

All publications, patents, and patent applications cited herein, whether supra or infra, are hereby incorporated by reference in their entirety to the same extent as if each individual publication, patent, or patent application was specifically and individually indicated to be incorporated by reference.

The term “comprising” which is synonymous with “including,” “containing,” or “characterized by,” is inclusive or open-ended and does not exclude additional, unrecited elements or method steps.

It will be noted that, as used in this specification and the appended claims, the singular forms “a,” “an” and “the” include plural referents unless the content clearly dictates otherwise. Thus, for example, reference to a “helical coil” includes one, two, or more helical coils.

In addition, unless otherwise indicated, numbers expressing quantities, constituents, distances, or other measurements used in the specification and claims are to be understood as optionally being modified by the term “about” or its synonyms. When the terms “about,” “approximately,” “substantially,” or the like are used in conjunction with a stated amount, value, or condition, it may be taken to mean an amount, value or condition that deviates by less than 20%, less than 10%, less than 5%, less than 1%, less than 0.1%, or less than 0.01% of the stated amount, value, or condition.

As used in the specification and appended claims, directional terms, such as “top,” “bottom,” “left,” “right,” “up,” “down,” “upper,” “lower,” “proximal,” “distal” and the like are used herein solely to indicate relative directions and are not otherwise intended to limit the scope of the disclosure or claims.

Where possible, like numbering of elements have been used in various figures. Furthermore, multiple instances of an element and or sub-elements of a parent element may each include separate letters appended to the element number. For example, two instances of a particular element “10” may be labeled as “10A” and “10B”. In that case, the element label may be used without an appended letter (e.g., “10”) to generally refer to all instances of the element or any one of the elements. Element labels including an appended letter (e.g., “10A”) can be used to refer to a specific instance of the element or to distinguish or draw attention to multiple uses of the element. Furthermore, an element label with an appended letter can be used to designate an alternative design, structure, function, implementation, and/or embodiment of an element. For example, two alternative exemplary embodiments of a particular element may be labeled as “10A” and “10B”. In that case, the element label may be used without an appended letter (e.g., “10”) to generally refer to all instances of the alternative embodiments or any one of the alternative embodiments.

Various aspects of the present devices and assemblies may be illustrated by describing components that are coupled, attached, and/or joined together. As used herein, the terms “coupled”, “attached”, and/or “joined” are used to indicate either a direct connection between two components or, where appropriate, an indirect connection to one another through intervening or intermediate components. In contrast, when a component is referred to as being “directly coupled”, “directly attached”, and/or “directly joined” to another component, there are no intervening elements present. Furthermore, as used herein, the terms “connection,” “connected,” and the like do not necessarily imply direct contact between the two or more elements.

Various aspects of the present devices, assemblies, and methods may be illustrated with reference to one or more exemplary embodiments. As used herein, the terms “embodiment,” “alternative embodiment” and “exemplary embodiment” mean “serving as an example, instance, or illustration,” and should not necessarily be construed as required or as preferred or advantageous over other embodiments disclosed herein.

Unless defined otherwise, all technical and scientific terms used herein have the same meaning as commonly understood by one of ordinary skill in the art to which the present disclosure pertains. Although a number of methods and materials similar to or equivalent to those described herein can be used in the practice of the present disclosure, the preferred materials and methods are described herein.

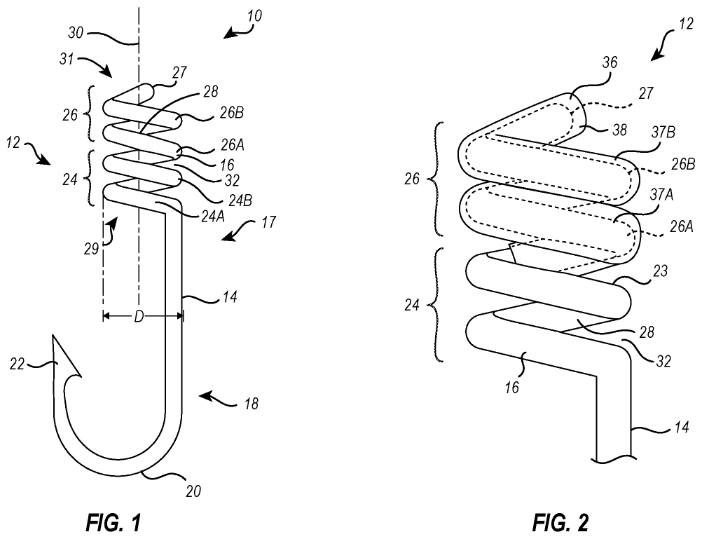

The present invention relates to helical line locks for removably securing a flexible line thereto. The helical line locks can be used independently or can be formed on or otherwise secured to a separate structure so that the line lock is used to removably secure the flexible line to the structure. By way of example and not by limitations, depicted in FIG. 1 is one embodiment of a fishhook 10 incorporating a helical line lock. Specifically, fishhook 10 includes a helical line lock 12 that comprises a helical coil 16 and an optional shank 14 extending therefrom. Shank 14 has a first end 17 and an opposing second end 18. In the depicted embodiment, shank 14 is linear. In alternative embodiments, shanks 14 can be curved, bent, or have a combination of curved, bent, and/or linear sections. Fishhook 10 further includes a bend 20 extending from second end 18 of shank 14 and a hook point 22 disposed at a terminal end of bend 20.

Helical coil 16 comprises a plurality of helical loops 23 disposed in consecutive order and extending from a first end 29 of helical coil 16 to an opposing second end 31. Helical coil 16/helical loops 23 can be formed from an elongated shaft that is coiled. Although the shaft typically has a cylindrical configuration with a circular transverse cross section, other transverse cross sections, such as polygonal, oval, elliptical, or the like, can also be used. First end 29 of helical coil 16 connects with first end 17 of shank 14. The plurality of helical loops 23 can comprise a plurality of mounting loops 24 and at least a pair of fixing loops 26. The plurality of mounting loops 24 extend in consecutive order from first end 17 of shank 14, i.e., they are disposed at first end 29 of helical coil 16. The at least a pair of fixing loops 26 extend in consecutive order from mounting loops 24, i.e., they are disposed at second end 31 of helical coil. Each of helical loops 23, mounting loops 24, and fixing loops 26 can spiral over an angle of at least 180°, 270°, 360° or 400° and at least partially or completely encircle a central passage 28 extending through helical coil 16 from first end 29 to second end 31. Thus, helical loops 23, mounting loops 24, and fixing loops 26 need not encircle 360° to form a “loop” as recited in the present specification and claims.

In the depicted embodiment, helical coil 16 and central passage 28 are linear and a longitudinal axis 30 centrally extends through passage 28. In alternative embodiments, helical coil 16 can be bent or curved so that central longitudinal axis 30 is correspondingly bent or curved. Mounting loops 24 are shown in FIG. 1 as including a first mounting loop 24A and an adjacent second mounting loop 24B. However, in other embodiments, other numbers of mounting loops 24 can be provided. For example, mounting loops 24 can comprise at least 2, 3, 4, 5, 6, 8 or 10 separate loops or can be in a range between any two of the foregoing. Each of the mounting loops 24 are disposed in consecutive order and at least partially encircling central passage 28. Other numbers mounting loops 24 can also be used.

Similarly, as also depicted in FIG. 1, fixing loops 26 can include a first fixing loop 26A and an adjacent second fixing loop 26B. However, in other embodiments, other numbers of fixing loops 26 can be provided. For example, fixing loops 26 can comprise at least 2, 3, 4, 5, 6, 8 or 10 separate loops or can be in a range between any two of the foregoing. Each of the fixing loops 26 are disposed in consecutive order and at least partially encircle central passage 28. Other numbers of fixing loops 26 can also be used. Fixing loop 26B/helical coil 16 terminates at a terminal tip 27 at second end 31.

As also shown in FIG. 1, each of loops 23/loops 24 and 26 are spaced apart so that a gap 32 is formed between each adjacent pair of loops 23/loops 24 and 26. As discussed below, gap 32 enables a flexible line to be passed between adjacent loops for securing the flexible line to line lock 12/helical coil 16. The size of gap 32 can depend upon location along helical coil 16, the size and intended use of line lock 12, and the size of the flexible line that will be used therewith. Where line lock 12/helical coil 16 is being used on a fishhook or is otherwise being used with fishing line or flexible line of comparable diameter, gap 32 commonly has a spacing of at least or less than 0.3 mm, 0.05 mm, 0.7 mm, 1 mm, 1.5 mm, 2 mm, or 3 mm or is in a range between any two of the foregoing. For example, gap 32 is commonly between 0.5 mm and 2 mm. Other dimensions can also be used. For example, where line lock 12/helical coil 16 is being used on other structures for securing larger diameter flexible line, such as cord or rope, gap 32 can be larger such as having a spacing or at least or less than 5 mm, 7 mm, 10 mm, 15 mm, 20 mm or 30 mm or in a range between any two of the foregoing.

In the embodiment depicted in FIG. 1, the size of gap 32 is the same or substantially the same between each adjacent pair of helical loops 23. However, as discussed below in alternative embodiments, the spacing between adjacent pairs of helical loops 23 can vary. In one embodiment, the size of gap 32 between fixing loops 26 can be larger or smaller than the size of gap 32 between mounting loops 24.

Each of loops 23/loops 24 and 26 also has an outside diameter D. Again, the size of the outside diameter D and the size of the diameter of passage 28 extending through helical coil 16 varies depending on the intended use of line lock 12/helical coil 16 and the size of the flexible line that will be used therewith. Where line lock 12/helical coil 16 is being used on a fishhook or is otherwise being used with fishing line or flexible line of comparable diameter, the outer diameter D of helical coil 16/loops 23/loops 24 and 26 is commonly at least or less than 2 mm, 4 mm, 6 mm, 8 mm, 10 mm or is in a range between any two of the foregoing. Where line lock 12/helical coil 16 is being used on other structures for securing larger diameter flexible line, such as cord or rope, the outer diameter D can be larger such as at least or less than 1.5 cm, 2 cm, 2.5 cm, 3 cm, 4 cm, 5 cm, 7 cm, 10 cm or in a range between any two of the foregoing. Other dimensions can also be used.

Helical coil 16 is commonly made from metal, such as steel and, more commonly, spring steel. The material is typically selected so that helical coil 16 has some flexibility that enables helical coil to resiliently bend without plastic deformation while still maintaining desired strength properties. The material selected for helical coil depends on the intended use. Thus, depending on intended use, other materials can also be used, such as other metals (like forged steel or aluminum), plastics, composites, and the like. Shank 14 and the remainder of fishhook 10 can also be made of the same material as helical coil 16 or can be made from a different material. For example, different parts of fishhook can be made of the same or different materials. In some embodiments, a corrosion resistant coating or plating can be applied over fishhook 10/helical coil 16. For example, the coating or plating can be comprised of nickel, zinc, tin, platinum, or other materials commonly used in corrosion resistant coating/plating. The plating is commonly applied by electroplating and has a thickness less than 0.5 mm, 0.2 mm, 0.05, 0.01 mm or 0.002 mm or is in a range between any two of the foregoing.

It is appreciated that fishhook 10 can have a variety of different configurations. For example, fishhook 10 can comprise a bait holder, worm, jig, circle, weedless, treble, siwash, octopus, aberdeen, kahle or other type of fishhook. Fishhook 10 can also comprise any type of fishing lure such as spoon lure, plug, jig, topwater crankbait, dough bait, fly, and the like. Thus, the term “fishhook” as used in the specification and appended claims is broadly intended to cover all types of fishing hooks and fishing lures that include a line lock as disclosed herein. To that end, fishhook 10 can also be defined as comprising helical coil 16, shank 14, a body 20 extending from shank 14, and hook point 22 disposed on body 20. Bend 20 can be one example of body 20. However, in alternative embodiments, body 20 can comprise the body of any other type of fishing lure or fishhook, such as those discussed above.

Turning to FIG. 2, line lock 12 also comprises a retainer 36 extending over at least a portion of fixing loops 26/helical loops 23. In the depicted embodiment, retainer 36 extends over both first fixing loop 26A and second fixing loop 26B so that retainer 36 radially encircles the shaft of each fixing loop 26A and 26B along the longitudinal axis thereof and also encircles central passage 28 extending through helical coil 16. Retainer 36 is typically made of a resiliently flexible material that is more flexible than the material used in the formation of helical coil 16. In one embodiment, the material for retainer 36 can comprise a polymer such as polyurethane, polyethylene, nylon, silicone, flexible polyvinyl chloride (PCV) and the like. Retainer 36 can also be made of a polymeric elastomer, rubber, expanded foam, natural products, such as sugar cane plastic, or other materials having comparable strength and resiliently flexible properties. The material for retainer 36 can have a Shore A scale durometer that is less than 80, 70, 60, 50, 40, or 30 or is in a range between any two of the foregoing. Retainer 36 is typically not made from metal and is typically made from a different material different from the material used to form helical coil 16.

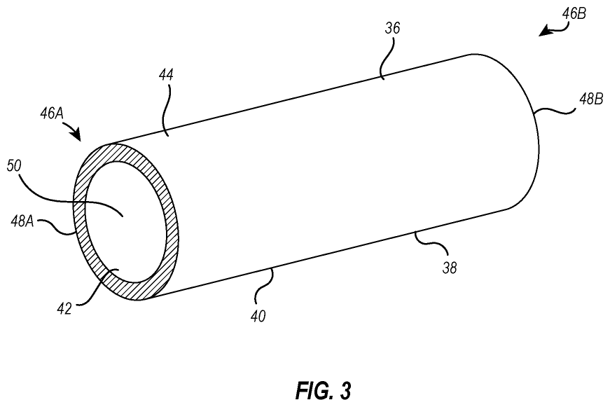

As depicted in FIG. 3, in one embodiment retainer 36 comprises a tube 38 having a sidewall 40 with an interior surface 42 and an opposing exterior surface 44 that longitudinally extend between a first end 46A terminating at a first end face 48A and a second end 46B terminating at a second end face 48B. Interior surface 42 and exterior surface 44 are both typically smooth and cylindrical. Interior surface 42 bounds a passage 50 extending between opposing end faces 48A and 48B. Passage 50 is sized to receive one or more of fixing loops 26. That is, tube 38 can be formed separately from helical coil 16, such as by molding or extruding, and then mounted to helical coil 16 by advancing terminal tip 27 through passage 50 while sliding retainer 36/tube 38 over and along fixing loops 26. In one embodiment, retainer 36/tube 38 is sized so that the inner diameter of passage 50 is slightly smaller than the outer diameter of the shaft forming fixing loops 26. As such, retainer 36/tube 38 outwardly stretches and produces a secure friction engagement with fixing loops 26 as retainer 36/tube 38 is advanced over fixing loops 26. In other embodiments, the inner diameter of passage 50 can be the same as or slightly larger than the outer diameter of the shaft forming fixing loops 26, thereby enabling easier mounting of retainer 36/tube 38 onto fixing loops 26. In one embodiment, an adhesive can be applied on fixing loops 26 and/or disposed within passage 50. The adhesive can act as a lubricant when mounting retainer 36/tube 38 onto fixing loops 26 and then ensure a fixed, secure engagement between retainer 36/tube 38 and fixing loops 26 once the adhesive sets. In one embodiment, the material for retainer 36/tube 38 is sufficiently flexible that tube 38 can be longitudinally folded or bent over an angle of at least 90°, 180°, 270, or 360° without plastic deformation.

In contrast to forming retainer 36 as a prefabricated tube that is subsequently mounted on helical coil 16/fixing loops 26, retainer 36 can be formed on helical coil 16/fixing loops 26 by spraying, dipping, sputter, painting or otherwise applying the material for retainer 36 in liquid form and then allowing the material to cure so as to form retainer 36. In still other embodiments, retainer 36 can be applied as a tape that is wrapped around one or more of fixing loops 26 or as a sleeve or sheet of material that is placed over one or more of fixing loops 26 and then heated for shrinking to securely attach in place. Other methods of formation and attachment can also be used.

In one embodiment retainer 36 can be clear or translucent. However, in other embodiments retainer 36 can be colored so as to function as a fish attractant. For example, retainer be can red, yellow, green, pink, orange, blue or shades thereof or combinations thereof. For example, retainer 36 can have alternating strips or lines of different colors. In one embodiment retainer 36 can be formed having at least two, three, or four different colors. Forming retainer 36 from bright colors, and particularly multiple different colors, can further accentuate the fish attractant capability of retainer 36.

With continued reference to FIG. 2, retainer 36 comprises a first retainer section 37A that covers at least a portion of fixing loop 26A and a second retainer section 37B that covers at least a portion of fixing loop 26B. Helical loops 23/fixing loops 26 are spaced and retainer 36 is sized so that when retainer 36 is disposed on fixing loops 24, the exterior surface of at least portions of overlapping retainer sections 37A and 37B are in direct contact. That is, no gap is formed between at least a portion of overlapping retainer sections 37A and 37B. In contrast, however, gap 32 remains open between adjacent mounting loops 24.

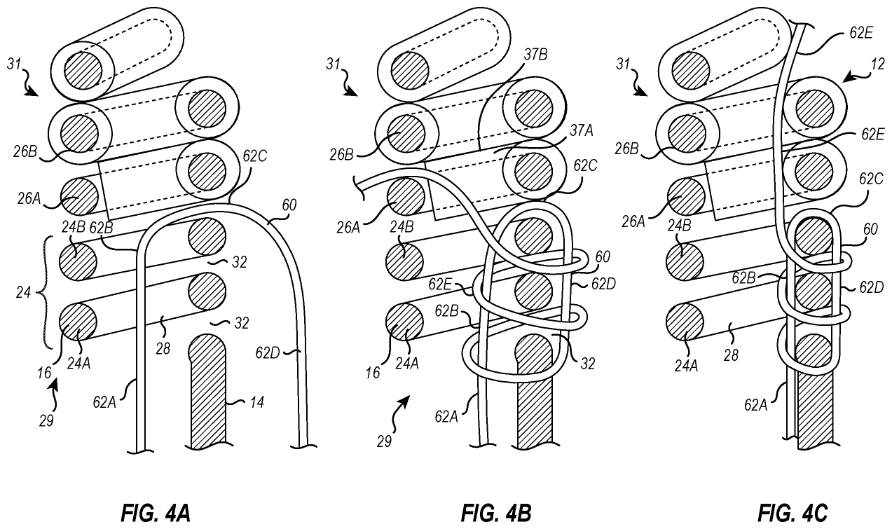

The gap spacing and lack thereof, as discussed above with regard to FIG. 2, assists with securing the flexible line to helical coil 16. For example, FIGS. 4A-4C are cross sectional views of line lock 12 shown in FIG. 2 and illustrating the attachment of a flexible line 60 thereto. In one embodiment, flexible line 60 can comprise any form of fishing line. In other embodiments, depending on the intended use and size of line lock 12/helical coil 16, flexible line 60 can comprise string, twine, suture, cord, rope or other types of line such as those having a solid core or are braded or twisted. Flexible line 60 can be made from material common to any type of flexible line such as polymers, cotton, silk, wool, hemp, natural fibers, synthetic fibers, and the like. Flexible line 60 is sufficiently flexible that it can be wound around a spool without plastic deformation. By way of example, the spool can have a diameter of 5 cm, 10 cm or 20 cm. The diameter of flexible line 60 also depends on the intended use and the size of helical coil 16. For example, when mounting flexible line 60 on a fishhook, flexible line may have a diameter of at least or less than 0.1 mm, 0.2 mm, 0.3 mm, 0.5 mm, 0.7 mm, 1 mm, or 1.5 mm or is in a range between any two of the foregoing. In other embodiments, the diameter of flexible line can be at least or less than 2 mm, 4 mm, 6 mm, 8 mm, 10 mm, 12 mm, 14 mm or 20 mm or in a range between any two of the foregoing. Other dimensions can also be used. In other alternative embodiments, flexible line 60 can comprise wire (sold core or braded), electrical wiring, bungee cord, or other flexible lines.

Initially during the mounting of flexible line 60, as shown in FIG. 4A, a first portion 62A of flexible line 60 is held or otherwise retained at shank 14 while an adjacent second portion 62B of flexible line 60 is helically wound around helical coil 16, starting at first end 29, so that second portion 62B passes between gaps 32 of mounting loops 24 and enters into passage 28 encircled mounting loops 24. Second portion 62B is wound until a third portion 62C of flexible line 60 adjacent to second portion 62B is passing out of helical coil 16 between mounting loop 24B and fixing loop 26. A fourth portion 62D of flexible line 60 adjacent to third portion 62C is then extended back to shank 14 outside of helical coil 16.

Turning to FIG. 4B, a fifth portion 62E of flexible line 60 adjacent to fourth portion 62D is then again helically wound around helical coil 16 starting at first end 29 so that fifth portion 62E passes between gaps 32 of mounting loops 24. Fifth portion 62E laterally wraps around first portion 62A and third portion 62 of flexible line 32 at each gap 32 as fifth portion 62E is spirally wrapped around helical coil 16. Fifth portion 62E is progressively wound around helical coil 16 from first end 29 toward second end 31 until fifth portion 62E meets with overlapping retainer sections 37A and 37B of retainer 36. Overlapping retainer sections 37A and 37B restrict fifth portion 62E from freely passing between fixing loops 26A and 26B.

Turning to FIG. 4C, a tensioning force is then applied to flexible line 60, such as by manually pulling on a free end of fifth portion 62E in a direction away from shank 14. The combination of helically winding fifth portion 62E about second portion 62B and fourth portion 62D and the tensioning of flexible line 60 causes flexible line 60 to sinch in a secure engagement about mounting loops 24. In addition, the tensioning and pulling of flexible line 60 causes fifth portion 62E (which can also be considered a sixth portion adjacent to fifth portion 62E) to pass between overlapping retainer sections 37A and 37B and into the central passage 28 of helical coil 16. The passing of fifth portion 62E between overlapping retainer sections 37A and 37B is at least in part accomplished by the tensioning force causing fifth portion 62E to compress retainer 36 as fifth portion 62E is pulled along retainer 36 toward second end 31 of helical coil 16. Retainer 36 resiliently rebounds after the passing of fifth portion 62E so that retainer sections 37A and 37B return to a direct overlapping engagement. The passing of fifth portion 62E between retainer sections 37A and 37B can also be facilitated in part by the tensioning force producing resilient flexing of helical coil 16.

In the assembled configuration shown in FIG. 4C, flexible line 60 is fixedly secured to line lock 12 which thus secures fishhook 12 to flexible line 60. Line lock 12 has a number of benefits in that flexible line 60 can be easily and quickly secured to line lock 12 by simply winding flexible line 60 about helical coil 16, as discussed above. The winding process is simple and quick in that because coil 16 is helical, the flexible line self-guides into the gaps between the loops during the winding process. As such, minimal dexterity and visual acuity is needed. In addition, there is no requirement for passing the fishing line through miniature eye or a required understanding of conventional knot tying techniques. In addition, flexible line 60 can be easily separated from line lock 12/helical coil 16 by simply unwinding fifth portion 62E of flexible line 60 from helical coil 16, i.e., winding fifth portion 62E in the opposite direction to how it was attached. Once fifth portion 62E is unwound from around second portion 62B and fourth portion 62D, flexible line 60 is freely removable from line lock 12/helical coil 16.

In one alternative method of use, it is appreciated that after flexible line 60 is fixedly secured to line lock 12/helical coil 16, as discussed above, that a second flexible line 60 can be secured to line lock 12/helical coil 16 using the same method as discussed above so that both the first and second flexible lines are concurrently secured to line lock 12/helical coil 16. For example, this is one method of how to secure two flexible electrical lines or two flexible securing lines together in an application where line lock 12/helical coil 16 is not part of a fishhook but has another application, such as discussed below. If needed, a third flexible line 60 can also be secured to line lock 12/helical coil 16 using the same above method so that three flexible lines are concurrently secured to line lock 12/helical coil 16.

The use of retainer 36 also achieves a number of unique benefits. For example, because at least portions of retainer sections 37A and 37B of retainer 36 are directly overlapping with no gap therebetween, retainer 36 prevents flexible line 60 from unintentionally unwinding about helical coil 16 after flexible line 60 is secured in place. That is, retainer 36 functions as a type of lock to prevent separation of flexible line 60 from helical coil 16. In addition, because retainer 36 comprises a resiliently flexible material that is softer and more flexible than helical spring 16, retainer 36 functions in part to protect flexible line 60 from damage as it is pulled between overlapping retainer sections 37A and 37B. That is, if retainer 36 was eliminated and fixing loops 26 were directly biased together, pulling flexible line 60 between the uncovered fixing loops 26 would typically damage flexible line 60 by either directly breaking flexible line 60 or by fraying, notching, stretching, or otherwise damaging flexible line 60 so that it becomes weaker and thus subject to a greater likelihood of failure during subsequent use. Furthermore, once flexible line 60 is damaged during the mounting stage, it can be further damaged during removal of flexible line 60 from between the uncovered fixing loops 26 and subsequent remounting of flexible line 60. Retainer 36 thus prevents or minimizes any damage to flexible line 60 as it is secured to and removed from line lock 12/helical coil 16, thereby minimizing any failure of flexible line 60. Likewise, retainer increases the strength of flexible line 60 via its ability to absorb shock, load, and strain to flexible line 60 both during attachment and removal from helical coil 16 and during use of flexible line 60 on line lock 12/helical coil 16. In addition, retainer 36 increases the test strength of line fixtures and at the point of connection and, depending on the thickness of retainer 36, can aid and increase the test strength of both the line and connection significantly as well as take load of other inline connections.

In addition, the use of retainer 36 can facilitate easier production of helical coil 16. That is, by using retainer 36, it is not necessary to form helical coil 16 with fixing loops 26A and 26B overlapping in direct contact. Rather, fixing loops 26A and 26B can be formed with a gap therebetween similar to the gap between mounting loops 24. However, once retainer 36 is disposed on fixing loops 26A and 26B, overlapping retainer sections 37A and 37B can be in direct contact. As such, by using retainer 36, helical coil 16 can be more easily and less expensively produced because helical coil 16 can be formed with even spacing between all of helical coils 16. Other benefits also exist.

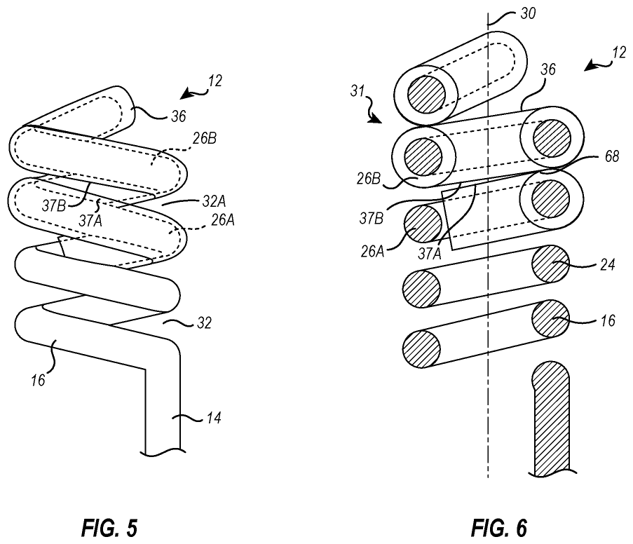

It is appreciated that helical coil 16 and retainer 36 can have a variety of different configurations depending on desired or intended use. For example, as depicted in FIG. 5, in one alternative embodiment retainer section 37A on fixing loop 26A and retainer section 37B on fixing loop 26B need not be in directly overlapping contact, as discussed above with regard to FIG. 2. Rather, a gap 32A can be formed between retainer sections 37A and 37B. However, in this embodiment the maximum gap 32A is typically less than the diameter of flexible line 60 being secured to helical coil 16 so as to prevent any unintentional unwinding of flexible line 60 on helical coil 16 after attachment. Commonly, maximum gap 32A is typically less than 80%, 60%, 40%, or 20% of the diameter of flexible line 60 or is in the range between any two of the foregoing. The width of maximum gap 32A between retainer sections 37A and 37B is typically smaller than the width of gap 32 between mounting loops 24A and 24B. That is, it is common to have the width of gap 32 between mounting loops 24 be larger than the diameter of the flexible line 60 being secured thereto so that flexible line 60 can be easily wrapped around and unwrapped from mounting loops 24 during use. As discussed below in more detail, the width of gap 32A can be controlled by adjusting the spacing between fixing loops 26A and 26B and/or by adjusting the thickness of retainer 36 and/or by adjusting the angle of orientation of one of fixing loops 26A and 26B relative to the other.

In the above discussed embodiments, fixing loops 26A and 26B are depicted as each being disposed at the same angle of orientation relative to axis 30 (FIG. 1). However, in an alternative embodiment, such as depicted in FIG. 6, one of fixing loops 26A or 26B can be angled at an orientation relative to axis 30 that is different from the other of fixing loops 26A or 26B. In this configuration retainer sections 37A and 37B only directly overlap or have a minimum gap 32A at an isolated location 68 as opposed to over an extended length of fixing loops 26A or 26B. As such, it is easier to pull flexible line 60 between fixing loops 26A or 26B having retainer 36 disposed thereon.

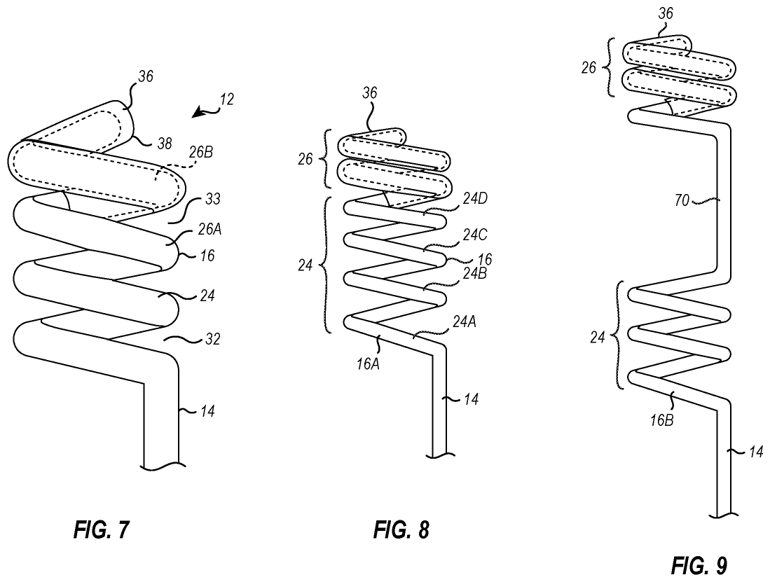

In another alternative embodiment, retainer 36 need not extend over both fixing loop 26A and fixing loop 26B but may extend over only one of fixing loop 26A or fixing loop 26B. For example, as depicted in FIG. 7, retainer 36 extends over fixing loop 26B but retainer 36 does not extend over fixing loop 26A. In this embodiment, helical coil 16 and/or retainer 36 are configured so that the exterior surface of retainer 36 on fixing loop 26B either directly contacts the exterior surface of fixing loop 26A or forms a minimum gap 33 therebetween that is less than the diameter of the flexible line 60 being secured thereto. Flexible line 60 is mounted on helical coil 16 in FIG. 7 using the same method as previously discussed above with regard to FIGS. 4A-4C. As with the prior embodiments, retainer 36 in this embodiment also prevents or minimizes damage to flexible line 60 as it is passed between fixing loop 26A and fixing loop 26B by compressing retainer 36 on fixing loop 26B while also preventing undesired unwinding of flexible line 60 from helical coil 16.

Depicted in FIG. 8 is another alternative embodiment of a helical coil 16A connected to shank 14. Helical coil 16A includes mounting loops 24 and fixing loops 26 with retainer 36 disposed on fixing loops 26. As previously discussed, however, in alternative embodiments any desired number of mounting loops 24 and fixing loops 26 be used. For example, in this embodiment four mounting loops 24A, 24B, 24C and 24D are being used. Other numbers can also be used. Flexible line 60 is mounted on helical coil 16A using the same method as previously discussed above with regard to FIGS. 4A-4C. Increasing the number of mounting loops 24 about which flexible line 60 is secured increases the surface area over which flexible line 60 is secured to helical coil 16A and increases the number of times that flexible line 60 is wrapped around second portion 62B and fourth portion 62D (FIG. 4B) of flexible line 60. As a result, increasing the number of mounting loops 24 increases the engagement between flexible line 60 and helical coil 16 so as to prevent any unwanted slipping of flexible line 60 relative to helical coil 16 and to more evenly distribute load along flexible line 60 to thereby help prevent failure of flexible line 60 during use.

Depicted in FIG. 9 is another alternative embodiment of a helical coil 16B connected to shank 14. Helical coil 16B includes mounting loops 24 and fixing loops 26 that are separated by a spacer shaft 70. Retainer 36 is disposed on fixing loops 26. Flexible line 60 can be secured to helical coil 16B using the same method as previously discussed with regard to FIGS. 4A-4C. However, using spacer shaft 70 provides increased spacing between mounting loops 24 and fixing loops 26 that can make it easier to align and wind flexible line 60 about mounting loops 24 and fixing loops 26.

Depicted in FIG. 10 is another alternative embodiment of a helical coil 16C connected to shank 14. Helical coil 16C includes mounting loops 24 and fixing loops 26 with retainer 36 disposed on fixing loops 26. In this embodiment the spacing between mounting loops 24 is farther apart than the spacing between fixing loops 26. The relatively wide spacing between mounting loops 24 makes it easier to wind flexible line 60 about mounting loops 24, as previously discussed. The relatively narrow spacing between fixing loops 26 enables the use of a relatively thin retainer 36 on fixing loops 26 while still achieving the desired direct contact or minimum gap spacing between retainer sections 37A and 37B of retainer 36, as previously discussed. Using a relatively thin retainer 36 can make it easier to form or mount retainer 36 on fixing loops 26 and can help to minimize any obstruction that may be caused by end face 48A (FIG. 3) of retainer 36 when flexible line 60 is being passed between fixing loops 26.

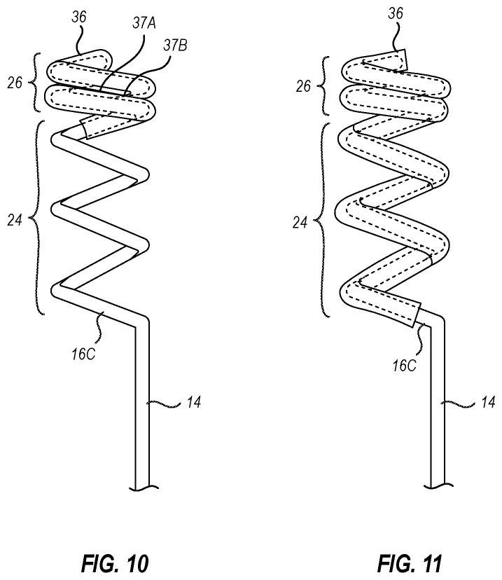

In the prior discussed embodiments, retainer 36 is disclosed as only extending over one or both of fixing loops 26A and 26B and not over mounting loops 24. In alternative embodiments, however, as shown in FIG. 11, retainer 36 can also extend over both fixing loops 26 and mounting loops 24. This configuration can further help prevent any damage to flexible line 60 by providing a soft, resiliently flexible surface against which flexible line 60 is secured. This can be particularly beneficial when an external impact is applied against mounting loops 24 during use. In addition, applying retainer 36 over both fixing loops 26 and mounting loops 24 may make it simpler to apply retainer 36, such as when retainer is being applied by painting, spraying, dipping or one of the other techniques as previously discussed herein. It is appreciated that all of the foregoing features in the different disclosed embodiments can also be mixed and matched to produce a variety of other alternative embodiments and that in each alternative embodiment flexible line 60 can be secured to the helical coil using the same method as previously discussed with regard to FIGS. 4A-4C.

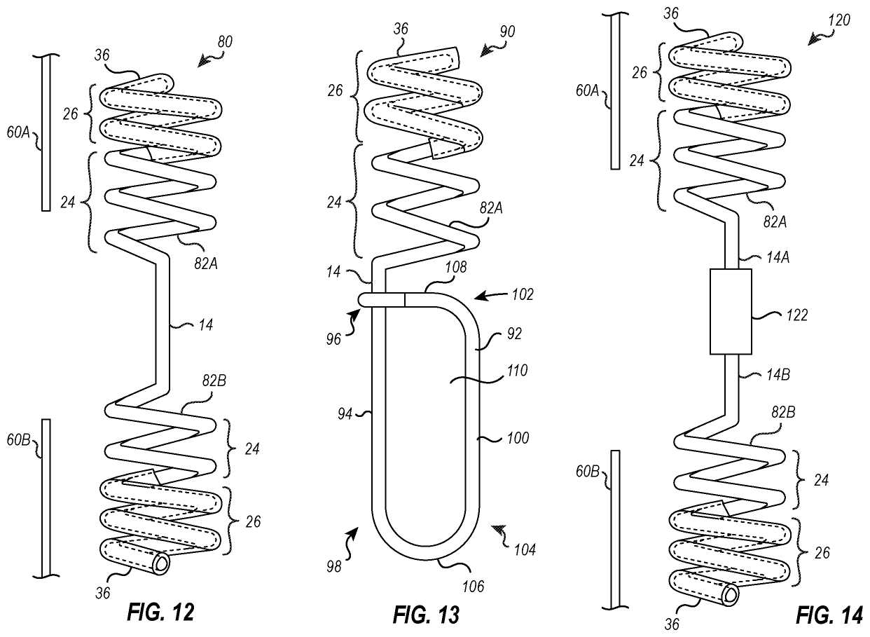

In contrast to being used on a fishhook, it is also appreciated that line locks/helical coils with retainers can be used on a variety of other structures where it is desired to secure a flexible line. For example, depicted in FIG. 12 is one embodiment of a flexible line coupler 80. Coupler 80 comprises a first helical coil 82A and a second helical coil 82B with shank 14 extending therebetween. Each of helical coils 82A and 82B can have the same configuration as previously discussed helical coil 16 and like elements between helical coils 82A and 82B and helical coil 16 are identified by like reference numbers. For example, each helical coil 82A and 82B can include mounting loops 24 and fixing loops 26 with retainer 36 disposed on fixing loops 26.

In alternative embodiments, helical coils 82A and 82B can also have the same configuration as any of the other helical coils discussed herein with any modification thereof. Helical coils 82A and 82B can have the same configuration or different configurations. For example, where helical coils 82A and 82B are designed for securing to different sizes or types of flexible lines, helical coils 82A and 82B can be separately configured to best couple with the corresponding flexible line size or type. Retainer 36 can also be applied and configured as with any embodiments disclosed herein.

During use, a first flexible line 60A can be removably secured to helical coil 82A while a second flexible line 60B can be removably secured to helical coil 82B. flexible lines 60A and 60B can be mounted on helical coils 82A and 82B, respectively, using the same method as previously discussed with regard to with regard to FIGS. 4A-4C. As a result, coupler 80 can be used to easily and quickly removably couple together flexible lines 60A and 60B having any desired diameter.

Depicted in FIG. 13 is another alternative embodiment of flexible line coupler 90. Like elements between flexible line coupler 90 and flexible line coupler 80 are identified by like reference numbers. Flexible line coupler 90 includes helical coil 82A with shank 14 extending therefrom and retainer 36 disposed on fixing loops 26 thereof. Helical coil 82A can be used to removably couple with flexible line 60A as previously discussed with regard to FIGS. 4A-4C. However, in contrast to including helical coil 82B, flexible line coupler 90 includes a clip 92 extending from shank 14. In the depicted embodiment, clip 92 includes a first arm 94 having a first end 96 coupled with shank 14 and an opposing second end 98. Clip 92 also includes a second arm 100 laterally spaced from first arm 94 and including a first end 102 and an opposing second end 104. A bend 106 extends between second end 98 of first arm 94 and second end 104 of second arm 100. A U-shaped catch 108 extends from first end 102 of second arm 100 back toward first arm 94. Clip 92 is made from a resiliently flexible material, such as spring steel.

In the depicted embodiment, clip 92 is in a closed position with catch 108 extending about first arm 94 or shank 14 so that clip 92 encircles a passage 110. By manually pressing second arm 100 toward first arm 94, catch 108 can be released from first arm 94 or shank 14 so as to move clip 92 into an open position wherein passage 110 is no longer completely encircled. During use, with clip 92 in the open position, a looped item can be passed over catch 108 and second arm 100 so as to be retained on clip 92. Clip 92 can then be moved back to the closed position to prevent separation of the looped item from clip 92. In alternative embodiments, clip 92 can have a variety of different configurations such as a lock snap commonly used on fishing swivels. Other configurations can also be used.

Turning to FIG. 14 is one embedment of flexible line swivel 120 that can incorporate line locks. Like elements between coupler 80 and swivel 120 are identified by like reference numbers. For example, swivel 120 includes helical coil 82A having retainer 36 disposed thereon and a shank 14A extending therefrom and also includes helical coil 82B having retainer 36 disposed thereon and a shank 14B extending therefrom. However, in contrast to coupler 80, swivel 120 includes a swivel joint 122 that rotatably couples shank 14A to shank 14B. Again, flexible lines 60A and 60B can be removably coupled to helical coils 82A and 82B, respectively, so that swivel removably couples together flexible lines 60A and 60B. However, in this embodiment, because of swivel joint 122, flexible lines 60A and 60B can freely rotate relative to each other. Other swivel configurations can also be formed. For example, coupler 90 can be converted to a swivel by simply placing swivel joint 122 on shank 14.

It is appreciated that the various alternative embodiments disclosed herein can be used in a variety of different ways including but not limited to towing connections, tie down connections, marine connections, hardware connections, automotive connections, electrical connections, e.g., electrically connecting two wires together by replacing flexible lines with wires, electrical fencing connections. Other alternative uses also exist.

Alternative configurations helical coils on which retainer 36 can be mounted and alternative methods of securing flexible line to helical coils on which retainer 36 can be mounted are disclosed in U.S. Pat. No. 7,836,629, issued Nov. 23, 2010, which is incorporated herein by specific reference.

Various alterations and/or modifications of the inventive features illustrated herein, and additional applications of the principles illustrated herein, which would occur to one skilled in the relevant art and having possession of this disclosure, can be made to the illustrated embodiments without departing from the spirit and scope of the invention as defined by the claims, and are to be considered within the scope of this disclosure. Thus, while various aspects and embodiments have been disclosed herein, other aspects and embodiments are contemplated. While a number of methods and components similar or equivalent to those described herein can be used to practice embodiments of the present disclosure, only certain components and methods are described herein.

It will also be appreciated that systems, processes, and/or products according to certain embodiments of the present disclosure may include, incorporate, or otherwise comprise properties features (e.g., components, members, elements, parts, and/or portions) described in other embodiments disclosed and/or described herein. Accordingly, the various features of certain embodiments can be compatible with, combined with, included in, and/or incorporated into other embodiments of the present disclosure. Thus, disclosure of certain features relative to a specific embodiment of the present disclosure should not be construed as limiting application or inclusion of said features to the specific embodiment. Rather, it will be appreciated that other embodiments can also include said features without necessarily departing from the scope of the present disclosure.

Moreover, unless a feature is described as requiring another feature in combination therewith, any feature herein may be combined with any other feature of a same or different embodiment disclosed herein. Furthermore, various well-known aspects of illustrative assemblies, processes, products, and the like are not described herein in particular detail in order to avoid obscuring aspects of the example embodiments. Such aspects are, however, also contemplated herein.

The present disclosure may be embodied in other specific forms without departing from its spirit or essential characteristics. The described embodiments are to be considered in all respects only as illustrative and not restrictive. The scope of the invention is, therefore, indicated by the appended claims rather than by the foregoing description. While certain embodiments and details have been included herein and in the attached disclosure for purposes of illustrating embodiments of the present disclosure, it will be apparent to those skilled in the art that various changes in the methods, products, devices, and apparatus disclosed herein may be made without departing from the scope of the disclosure or of the invention, which is defined in the appended claims. All changes which come within the meaning and range of equivalency of the claims are to be embraced within their scope.

1. A helical line lock for securing a flexible line thereto, the helical line lock comprising:
a shank having a first end and an opposing second end; and
a first helical coil extending from the first end of the shank, the first helical coil comprising a plurality of helical loops disposed in consecutive order, the plurality of helical loops comprising:
a plurality mounting loops extending in consecutive order from the first end of the shank; and
a pair of fixing loops extending in consecutive order following the plurality of mounting loops;
a retainer disposed over at least a portion of one of the pair of fixing loops, the retainer being comprised of a resiliently flexible material that is more flexible than the first helical coil.

2. The helical line lock as recited in claim 1, wherein the retainer is comprised of a polymer, elastomer or a rubber.

3. The helical line lock as recited in claim 1, wherein the resiliently flexible material of the retainer has Shore A scale durometer of less than 80.

4. The helical line lock as recited in claim 1, wherein the retainer comprises a tube of the resiliently flexible polymeric material disposed over at least a portion of one of the pair of fixing loops.

5. The helical line lock as recited in claim 1, wherein the helical coil is comprised of a metal.

6. The helical line lock as recited in claim 1, wherein the retainer does not extend over each of the plurality mounting loops.

7. The helical line lock as recited in claim 1, wherein the retainer extends over at least a portion of each of the pair of fixing loops.

8. The helical line lock as recited in claim 7, wherein the pair of fixing loops comprise a first fixing loop and a second fixing loop, and wherein retainer comprises a first retainer portion extending over at least a portion of the first fixing loop and a second retainer portion extending over at least a portion of the second fixing loop, the first retainer portion overlaying and being in direct contact with the second retainer portion.

9. The helical line lock as recited in claim 1, wherein the retainer is disposed over both the plurality mounting loops and the pair of fixing loops.

10. The helical line lock as recited in claim 1, further comprising:
each of the plurality of mounting loops being spaced apart by a first distance;
the pair of fixing loops being spaced apart by a second distance, the first distance being different from the second distance.

11. The helical line lock as recited in claim 1, further comprising:
a second helical coil extending from the second end of the shank, the second helical coil comprising a plurality of second helical loops disposed in consecutive order, the plurality of second helical loops comprising:
a plurality second mounting loops extending in consecutive order from the second end of the shank; and
a pair of second fixing loops extending in consecutive order following the plurality of second mounting loops;
a second retainer disposed over at least a portion of one of the pair of second fixing loops, the second retainer being comprised of a resiliently flexible material that is more flexible than the second helical coil.

12. The helical line lock as recited in claim 1, wherein the retainer has at least two different colors.

13. A fishhook comprising:
the helical line lock as recited in claim 1;
a body extending from the second end of the shank; and
a hook point disposed body.

14. The fishhook as recited in claim 13, wherein the body comprises a bend and the hook point is disposed at a terminal end of the bend.

15. A method for forming a helical line lock for use in securing to a flexible line, the method comprising:
obtaining a base member comprising:
a shank having a first end and an opposing second end; and
a first helical coil extending from the first end of the shank, the first helical coil comprising a plurality of helical loops disposed in consecutive order, the plurality of helical loops comprising:
a plurality mounting loops extending in consecutive order from the first end of the shank; and
a pair of fixing loops extending in consecutive order following the plurality of mounting loops; and
applying a retainer over at least a portion of one of the pair of fixing loops, the retainer being comprised of a resiliently flexible polymeric, elastomeric or rubber material.

16. The method as recited in claim 15, wherein the first helical coil is comprised of a coiled elongated shaft and the retainer comprises a tube, and wherein applying the retainer comprises sliding the tube over the coiled elongated shaft so that the tube covers at least a portion of one of the pair of fixing loops.

17. The method as recited in claim 15, wherein applying the retainer comprises:
applying a liquid material over at least a portion of one of the pair of fixing loops; and
allowing the liquid material to set so as to form the retainer.

18. The method as recited in claim 15, wherein applying the retainer comprises applying the retainer over at least a portion of each of the plurality mounting loops.

19-21. (canceled)
